(19) United States
(12) Patent Application Publication
(10) Pub. No.: US 2007/0104914 A1
(43) Pub. Date: May 10, 2007

(54) ADHESIVE STRIP WITH AN ACRYLATE FOAM, STRIP-SHAPED SUBSTRATE

(75) Inventors: Anke Lewin, Duesseldorf (DE); Wolfgang Klauck, Meerbusch (DE); Reinhold Domanski, Neuwied (DE)

Correspondence Address: HENKEL CORPORATION, THE TRIAD, SUITE 200, 2200 RENAISSANCE BLVD., GULPH MILLS, PA, 19406, US

(73) Assignees: Henkel Kommanditgesellschaft auf Aktien (Henkel KGaA), Duesseldorf (DE); Lohmann GmbH & Co.KG, Neuwied (DE)

(21) Appl. No.: 11/609,361

(22) Filed: Dec. 12, 2006

Related U.S. Application Data
(63) Continuation of application No. PCT/EP05/06180, filed on Jun. 9, 2005.

(30) Foreign Application Priority Data
Jun. 25, 2004 (DE) 20 2004 009 996.9

(51) Int. Cl. B32B 33/00

(52) U.S. Cl. 428/40.1; 428/56

(57) ABSTRACT

Adhesive tape with a two-sided acrylate foam backing, each side coated with two different adhesives in distinct segments, one adhesive having high initial bond strength and the other having high ultimate bond strength.

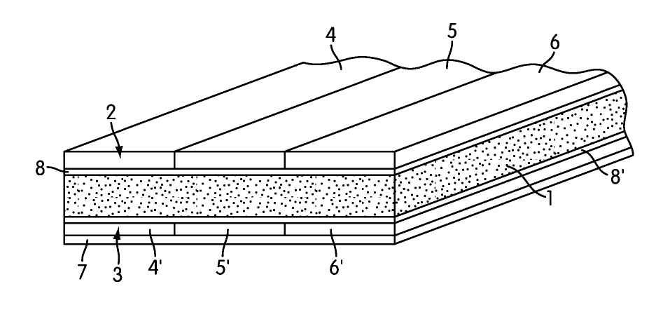

### CROSS REFERENCE TO RELATED APPLICATION

This application is a continuation under 35 U.S.C. § 365(c) and 35 U.S.C. § 120 of international application PCT/EP2005/006180, filed on Jun. 9, 2005. This application also claims priority under 35 U.S.C. § 119 of DE 20 2004 009 996.9, filed Jun. 25, 2004, which is incorporated herein by reference in its entirety.

### BACKGROUND OF THE INVENTION

The invention relates to an adhesive tape that comprises a substrate with a first and a second side.

Adhesive tapes are known in a great number of forms and are available on the market. They generally consist of a substrate made of a relatively thin, flexible plastic film that is coated with an adhesive. Typical substrate materials are polypropylene, polyethylene, polyethylene terephthalate, polyvinyl chloride and acetate films as well as woven substrates and foamed substrates. Adhesive tapes are used to join or bundle up objects, for sealing or for example in paint jobs for masking, i.e. for covering up areas that should not be covered with paint.

The substrate of adhesive tapes can be coated with adhesive on one or both sides. Adhesive tapes coated with adhesive on both sides are also known as mounting tapes and are used to fasten objects with at least one flat side to a flat background. Pictures, mirrors or signs for example, can be fixed to a wall with them.

The adhesives used for the manufacture of adhesive tapes can be selected from a great number of common materials. They can be e.g. SIS rubbers, SBS rubbers, polyisobutylenes, polyisoprenes, polyacrylates and natural rubbers, optionally blended with tackifying natural and/or synthetic resins. Because of their different chemical compositions, the various adhesives naturally have different properties. Important characteristics for the quality of a mounting tape are initial adhesion, adhesive strength to the substrate, cohesion of the adhesive, heat stability and final strength. When applying the adhesive tape, it is important to press down the mounting tape well onto the particular background in order to guarantee a good wetting of the tape to the background. The tape reaches its final strength when the maximum possible wetting of the adhesive to the background is attained. The pressure sensitive adhesive generally needs some time to flow into the microscopic irregularities of the surface. Moreover, the process is promoted by higher temperatures and a strong pressing force. Adhesives that achieve a high final strength and a high heat stability generally require a relatively long time for this wetting process to occur. Having said that, there are adhesives that have a high tack and flow relatively well: these adhesives wet the adhesion substrate significantly faster and therefore also stick faster to the particular background. However, these adhesives do not generally attain high final strengths and heat stabilities.

### DESCRIPTION OF THE INVENTION

The object of the present invention is to provide an adhesive tape that firstly immediately affords a relatively highly tough bond and after some time affords a very highly tough bond and secondly is suitable for bonding objects that exhibit minor surface irregularities.

This object is achieved by an adhesive tape of the type cited in the introduction, wherein the substrate is a film coated tape of a closed cell foam of polyethylene or of an ethylene-vinyl acetate copolymer, and the first and the second side each have at least two segments that are coated with different adhesives, of which at least one first adhesive has a high initial adhesion strength and at least one second adhesive has a high final adhesion strength.

Fundamentally, an adhesive tape that is coated on one side with different adhesives on adjacent segments of the substrate is known from the patent application US 2002/0108564 A1. The combination with a film coated polyethylene foam tape, which is essential to the invention and which affords high performance mounting tapes, is not disclosed in the cited patent application, however.

The film coated polyethylene foam tape has a porous core and a closed cell foamed smooth surface on both sides.

Segments are advantageous that carry the different adhesives in the form of adjacent stripes running lengthways along the adhesive tape. This type of tape can be easily manufactured by applying stripes of adhesive onto the substrate, and also offers considerable advantages in use.

A plurality of adhesives arranged as adjacent stripes can be combined with each other on each side of the adhesive tape, wherein the number of striped segments is not limited. However, it is particularly advantageous for the inventive adhesive tape when each side of the substrate is coated with a first striped segment with an adhesive with a high initial adhesion strength, and is also coated with an adhesive with a high final adhesion strength in two additional striped segments that border on the long sides of the first striped segment. Thus, the stripes of adhesive with a high initial adhesion strength run along the middle of the tape, whereas the stripes of adhesive with a high final adhesion strength run along the edges. The three stripes can each occupy one third of the width of the adhesive tape; however it is also possible to vary the widths of the stripes to favor a high initial adhesion strength or to favor a high final adhesion strength.

Advantageously, the adhesive tape exhibits an adhesion strength on stainless steel of >12 N/25 mm after one minute and an adhesion strength of >30 N/25 mm after 24 hours, the adhesion strength corresponding to the peel force measured according to the test method PSTC-1. The test method was developed by the Pressure Sensitive Tape Council, an association of American manufacturers of adhesive tapes. According to the test conditions, the adhesion strength is the force required to peel off an adhesive strip of defined width under defined conditions (peeling angle, contact pressure, speed) from a standard test plate. For the test, a piece of adhesive tape with a length of ca. 400 mm and a sample width of 25 mm is applied onto a 200 mm long, 50 mm wide and ca. 2 mm thick stainless steel plate and uniformly pressed on by means of a rubber coated metal roller weighing 2 kg. Ca. 25 mm of the adhesive tape is peeled off from the steel plate that was prepared. The steel plate is fixed in the test machine by a driving clip, and the free end of the tape is fastened with another clip. The adhesive tape is peeled off the steel plate at an angle of 180° with a defined speed of 300±30 mm per minute, the test machine displaying the value of the adhesion force. At the end of the test a mean value is calculated, which represents the adhesion strength to steel. This value is printed out with the force (N) that is required for peeling off the adhesive tape from the steel plate for a sample width of 25 mm.

Particularly preferably, the adhesive and the whole adhesive tape exhibit the following properties:

Adhesive with high initial adhesion strength:

Peel strength on steel after 1 minute: >40 N/25 mm

Peel strength on steel after 24 hours: >50 N/25 mm

Temperature resistance ≧50° C.

Adhesive with high final adhesion strength:

Peel strength on steel after 1 minute: >15 N/25 mm

Peel strength on steel after 24 hours: >30 N/25 mm

Temperature resistance ≧100° C.

Whole adhesive tape:

Peel strength on steel after 1 minute: >12 N/25 mm

Peel strength on steel after 24 hours: >30 N/25 mm

Temperature resistance ≧95° C.

In addition to the adhesion strength, the resistance to high temperatures is a further characteristic of the quality of an adhesive tape. The adhesive with a high initial adhesion strength advantageously exhibits a temperature resistance of ≧70° C. and the adhesive with a high final adhesion strength a temperature resistance of ≧100° C. The adhesive with a high initial adhesion strength is advantageously a synthetic rubber adhesive, preferably a styrene-isoprene-styrene rubber, and the adhesive with a high final adhesion strength is advantageously an acrylate adhesive, preferably an acrylate adhesive based on 2-ethylacrylate.

The substrate of the adhesive tape advantageously consists of closed cell foamed ethylene-vinyl acetate copolymer. This substrate is advantageously film coated on both sides with a non-foamed polyethylene film.

Advantageously, the adhesive tape possesses a separation film on at least one of the sides of the substrate coated with adhesive. This type of separation film is also called a release liner. It facilitates the handling of the adhesive tape prior to use and in particular enables the tape to be rolled up and easily unwound when using the adhesive tape.

The inventive adhesive tape can be manufactured by means of well known processes from the prior art, in which the film coated foamed substrate is coated with stripes of the different adhesives by means of a coating machine.

An embodiment of the invention is described below in more detail with the help of the drawing.

The figure shows an inventive adhesive tape in perspective view. It consists of a substrate 1 of foamed polyethylene, which is film coated on both sides with a non-foamed polyethylene film 8 and 8′. Segments 4, 5 and 6 and 4′, 5′ and 6′ are coated with adhesive and arranged on the first side 2 and the second side 3 of the substrate. Here, the segments 5 and 5′ are coated with an adhesive with a high initial adhesion strength and the segments 4, 4′, 6 and 6′ with an adhesive with a high final adhesion strength. A release liner 7 is arranged on one side of the adhesive tape.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

What is claimed is:

1. An adhesive tape comprising a acrylate foam tape backing having first and second sides, wherein the first and second sides each have at least two segments each coated with a different adhesive, wherein at least one first adhesive has a high initial bond strength and at least one second adhesive has a high ultimate bond strength.

2. The adhesive tape of claim 1, wherein the segments comprise adjacent strips extending in the longitudinal direction of the adhesive tape.

3. The adhesive tape of claim 2, wherein on each side of the backing a first strip-form segment is coated with an adhesive having high initial bond strength and two further strip-form segments on either side of the first strip-formed segment are coated with an adhesive having high ultimate bond strength.

4. The adhesive tape of claim 1, having after one minute a bond strength of >12 N/25 mm and after 24 hours a bond strength of >30 N/25 mm, as measured by the PSTC-1 test method on stainless steel.

5. The adhesive tape of claim 1, wherein the adhesive having high initial bond strength has a temperature stability of ≧70° C. and the adhesive having high ultimate bond strength has a temperature stability of ≧100° C.

6. The adhesive tape of claim 1, wherein the adhesive having high initial bond strength comprises a synthetic rubber adhesive and the adhesive having high ultimate bond strength comprises an acrylate adhesive.

7. The adhesive tape of claim 1, wherein the backing comprises of a closed-cell acrylate foam.

8. The adhesive tape of claim 1, having a release film o at least one of the adhesive-coated sides of the backing.

9. The adhesive tape of claim 2, having after one minute a bond strength of >12 N/25 mm and after 24 hours a bond strength of >30 N/25 mm, as measured by the PSTC-1 test method on stainless steel.

10. The adhesive tape of claim 3, having after one minute a bond strength of >12 N/25 mm and after 24 hours a bond strength of >30 N/25 mm, as measured by the PSTC-1 test method on stainless steel.

11. The adhesive tape of claim 2, wherein the adhesive having high initial bond strength has a temperature stability of ≧70° C. and the adhesive having high ultimate bond strength has a temperature stability of ≧100° C.

12. The adhesive tape of claim 3, wherein the adhesive having high initial bond strength has a temperature stability of ≧70° C. and the adhesive having high ultimate bond strength has a temperature stability of ≧100° C.

13. The adhesive tape of claim 4, wherein the adhesive having high initial bond strength has a temperature stability of ≧70° C. and the adhesive having high ultimate bond strength has a temperature stability of ≧100° C.

14. The adhesive tape of claim 2, wherein the adhesive having high initial bond strength comprises a synthetic rubber adhesive and the adhesive having high ultimate bond strength comprises an acrylate adhesive.

15. The adhesive tape of claim 3, wherein the adhesive having high initial bond strength comprises a synthetic rubber adhesive and the adhesive having high ultimate bond strength comprises an acrylate adhesive.

16. The adhesive tape of claim 4, wherein the adhesive having high initial bond strength comprises a synthetic rubber adhesive and the adhesive having high ultimate bond strength comprises an acrylate adhesive.

17. The adhesive tape of claim 5, wherein the adhesive having high initial bond strength comprises a synthetic rubber adhesive and the adhesive having high ultimate bond strength comprises an acrylate adhesive.

18. The adhesive tape of claim 4, wherein the backing comprises a closed-cell acrylate foam.

19. The adhesive tape of claim 5, wherein the backing comprises a closed-cell acrylate foam.

20. The adhesive tape of claim 6, wherein the backing comprises a closed-cell acrylate foam.
